(19) United States
(12) Patent Application Publication
(10) Pub. No.: US 2002/0174282 A1
(43) Pub. Date: Nov. 21, 2002

(54) Multiprocessor system

(75) Inventors: Hiroshi Murakami, Kawaski (JP); Toru Watabe, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/170,189

(22) Filed: Jun. 13, 2002

Related U.S. Application Data
(63) Continuation of application No. PCT/JP99/07014, filed on Dec. 14, 1999.

(51) Int. Cl. G06F 13/36

(52) U.S. Cl. 710/306; 710/260

(57) ABSTRACT

A multiprocessor system provided with a plurality of ports (54-1 to 54-n+m) forming processors or bus bridge units, is constructed to include a system controller (51, 51A) coupling the plurality of ports via address buses and control signal lines, a data bus controller (52) coupling the plurality of ports via data buses, and a conversion unit (58, 58A) converting at least one of commands, data and control signals at an intermediate part of a transfer path which is formed by at least one of the address buses, the data buses and the control signal lines.

### TECHNICAL FIELD

The present invention generally relates to multiprocessor systems, and more particularly to a multiprocessor system which is mounted with a relatively large number of processors.

### BACKGROUND ART

FIG. 1 is a system block diagram showing an example of a structure of a conventional multiprocessor system. The multiprocessor system generally includes a system controller 1, a data bus controller 2, a main storage 3, and a plurality of ports 4-1 through 4-n+m which are connected as shown in FIG. 1. More particularly, the ports 4-1 through 4-n+m form processors such as CPUs, bus bridge units or the like. It will be assumed for the sake of convenience that the ports 4-1 through 4-n respectively form processors P#1 through P#n, and the ports 4-n+1 through 4-n+m respectively form bus bridge units B#1 through B#m. It is of course possible to provide a plurality of system controllers in place of the system controller 1.

The ports 4-1 through 4-n+m are mutually connected via a first bus system 5. More particularly, the ports 4-1 through 4-n+m are connected via the system controller 1 and address buses and control signal lines of the first bus system 5, and are connected via the data bus controller 2 and data buses of the first bus system 5. In addition, the ports 4-n+1 through 4-n+m which form the bus bridge units B#1 through B#m are connected to input/output (I/O) circuits 7-n+1 through 7-n+m via a second bus system 6 which is different from the first bus system 5. The input/output circuits 7-n+1 through 7-n+m are formed by external storage units, network apparatuses or the like.

The address buses transfer commands between the ports 4-1 through 4-n+m and the system controller 1, and the data buses transfer data between the ports 4-1 through 4-n+m and the main storage 3 via the data bus controller 2. The control signal lines supply control signals from the system controller 1 to the ports 4-1 through 4-n+m, and control the operations of the ports 4-1 through 4-n+m.

One address bus may be provided for each of the ports 4-1 through 4-n+m or, one address bus may be shared by a plurality of ports. In addition, the data bus controller 2 may have a handshake structure for directly connecting the data buses or, a structure using a crossbar switch.

Next, a description will be given of the operation of the conventional multiprocessor system shown in FIG. 1.

For example, when an interrupt is generated from the bus bridge unit B#1 of the port 4-n+1 to the processor P#1 of the port 4-2, the following process is carried out. First, when the port 4-n+1 requests the right to use the bus, an arbitration is carried out, and the port 4-n+1 acquires the right to use the bus. The system controller 1 instructs the timing, and the port 4-n+1 issues an interrupt command. The interrupt command is supplied to the port 4-2 via the address bus and the system controller 1. The system controller 1 instructs the timing, and the port 4-n+1 issues data according to the interrupt. The data is supplied to the port 4-2 via the data bus and the data bus controller 2.

In addition, the following process is carried out in the case of a data read from the port 4-2 to the port 4-n+1, for example. First, when the port 4-2 requests the right to use the bus, an arbitration is carried out, and the port 4-2 acquires the right to use the bus. The system controller 1 instructs the timing, and the port 4-2 issues a read request command. The read request command is supplied to the port 4-n+1 via the system controller 1. When preparations for a data output is made, the port 4-n+1 notifies the system controller 1 accordingly by a control signal. Further, the system controller 1 instructs the timing, and the port 4-n+1 issues a read data. In this case, since the output of the read data is waited, it is possible to detect the completion of the operation and the generation of an error.

On the other hand, the following process is carried out in the case of a data write from the port 4-2 to the port 4-n+1. First, when the port 4-2 requests the right to use the bus, an arbitration is carried out, and the port 4-2 acquires the right to use the bus. The system controller 1 instructs the timing, and the port 4-2 issues a write request command. The write request command is supplied to the port 4-n+1 via the address bus and the system controller 1. When preparations for a data input is made, the port 4-n+1 notifies the system controller 1 by a control signal. In addition, the system controller 1 instructs the timing, and the port 4-2 issues a write data. In the case of the data write, it is generally the case that the importance is placed on the operation performance and the process advances to the next process after the data is supplied to the port. In other words, no confirmation is made to determine whether or not the data write to a destination has been completed, and a notification is made asynchronously (by interrupt) if an error is generated.

When carrying out the above described operations such as the interrupt, read and write, a port ID of the other port is included. The port can be specified by two kinds of methods depending on the transmission system of the bus. One method includes the port ID in the command or data, and is mainly used by the bus which makes a serial transfer. The other method transmits the port ID for a predetermined time using the bus signal line itself, and is mainly used by the bus which makes a parallel transfer. The port ID is a number for identification, which is allocated for each port, and normally, a value peculiar to each port is used as the port ID. In the above described case, the port IDs of the ports 4-2 and 4-n+1 respectively are 2 and n+1. Such port IDs are used when specifying the port 4-2 which is to be interrupted and when specifying the port 4-n+1 which is the interrupt source.

FIG. 2 is a system block diagram for explaining a distributed arbitration. For the sake of convenience, FIG. 2 only shows one system controller 1 and three ports 4-1 through 4-3. The system controller 1 includes an arbitration unit 11 and a request generator 12. In addition, each of the ports 4-1 through 4-3 includes an arbitration unit 41 and a request generator 42.

In the distributed arbitration, all modules which use the bus, that is, the system controller 1 and each of the ports 4-1 through 4-3, receive bus using requests from all modules, and each module carry out an arbitration and a judgement of the bus using right. For this reason, each module has an arbitration unit and a request generator. According to the distributed arbitration, it is possible to carry out the arbitration in a short time, that is, with a short latency.

FIG. 3 is a diagram showing operation timings of the system controller 11 for explaining the distributed arbitration. FIG. 4 is a diagram showing operation timings of a port for explaining the distributed arbitration. FIG. 4 shows the operation timings of the port 4-2, for example. In FIGS. 3 and 4, RQS denotes a request from the request generator 12 of the system controller 1, and RQ1 through RQ3 respectively denote requests from the request generators 42 of the ports 4-1 through 4-3.

In the system controller 1, the bus using right is recognized at the timings shown in FIG. 3, in an order of the system controller 1, the port 4-2 and the port 4-1. A command issuer on the address bus is recognized at the timings shown in FIG. 3 in an order of the port 4-2 and the port 4-1.

On the other hand, in the port 4-2, the bus using right is recognized at the timings shown in FIG. 4 in an order of the system controller 1, the port 4-2 and the port 4-1. A command issuer on the address bus is recognized at the timings shown in FIG. 4 in an order of the system controller 1, the port 4-2 and the port 4-1.

As may be seen from FIGS. 3 and 4, the system controller 1 and each of the ports 4-1 through 4-3 are directly connected, and an arbitration result and a command on the bus are obtained at the same timing in the system controller 1 and each of the ports 4-1 through 4-3. For this reason, no inconveniences such as a bus-fight is generated wherein the bus is used simultaneously by a plurality of modules.

FIG. 5 is a system block diagram for explaining a concentrated arbitration. For the sake of convenience, FIG. 5 only shows one system controller 1 and three ports 4-1 through 4-3. The system controller 1 includes an arbitration controller 13, a request generator 14, and a command generator 15. In addition, each of the ports 4-1 through 4-3 includes a request generator 44 and a command generator 45.

In the concentrated arbitration, requests from all modules are collected by a single arbitration controller so as to judge the bus using right, and the operation of each port is controlled according to a grant signal which grants the bus using right. In FIG. 5, the arbitration controller 13 is provided within the system controller 1, to control the operation of each of the ports 4-1 through 4-3. In this case, no arbitration unit needs to be provided in any of the ports 4-1 through 4-3, and there is no need to directly exchange the request among the ports 4-1 through 4-3. As a result, the system structure can be simplified, and the system control becomes relatively easy.

FIG. 6 is a diagram showing operation timings of the system controller 11 for explaining the concentrated arbitration. In FIG. 6, RQS denotes a request from the request generator 14 of the system controller 1, RQ1 through RQ3 respectively denote requests from the request generators 44 of the ports 4-1 through 4-3, GRANT1 through GRANT3 respectively denote a grant signal from the arbitration controller 13 of the system controller 1, and BUSY denotes busy signals from the command generator 15 of the system controller 1 and the command generators 45 of the ports 4-1 through 4-3.

In the system controller 1, the bus using right is recognized at the timings shown in FIG. 6, in an order of the system controller 1, the port 4-2 and the port 4-1. A command issuer on the address bus is recognized at the timings shown in FIG. 6 in an order of the port 4-2 and the port 4-1.

Therefore, the conventional multiprocessor system is constructed so that a plurality of processors, bus bridge units and the like operate in cooperation.

However, the conventional multiprocessor system has a first problem in that it is impossible to easily expand the scale and functions of the system.

For example, when an attempt is made to expand the multiprocessor system into a large-scale system by increasing the number of processors and bus bridge units, each port is limited by an upper limit of the number of corresponding ports, and the system cannot be expanded easily. The upper limit of the number of ports is determined by a range of the values of the port IDs that can be internally handled by each port according to the serial transfer system described above, and is determined by the number of signal lines of the bus according to the parallel transfer system described above. For this reason, in order to build a large-scale system which exceeds the upper limit of the number of ports, it is necessary to newly design and create the processors and bus bridge units which are formed by the ports, thereby requiring high cost and time.

On the other hand, due to the recent technological improvements, there are demands to realize a so-called scalable implementation in the multiprocessor system. The scalable implementation enables an arbitrary combination of a plurality of processors forming the multiprocessor system. According to the multiprocessor system which can cope with this scalable implementation, the entire system can be used as a single computer or, the plurality of processors provided in the multiprocessor system may be grouped so that each of the groups is virtually used as a separate computer (that is, virtual computer).

Under such scalable implementation, the processors forming the virtual computer change dynamically, and an inconvenience occurs if a specific role is constantly allocated to a specific processor. For example, there is a possibility that a processor which is allocated to carry out an interrupt process may be changed at the same time when the structure of the virtual computer is changed. Accordingly, one port must be made accessible by some means with respect to all ports connected to the bus.

In addition, when newly introducing a port having an unsupported instruction into the multiprocessor system, all of the other ports must be able to cope with the issuance or reception of the unsupported instruction. For example, when newly introducing a high-performance processor having a new unsupported instruction into the multiprocessor system, the unsupported instruction normally cannot be used, but if the unsupported instruction is accidentally issued by a programming error or the like, there is a possibility that an erroneous operation or a fault may be generated in the other ports. Accordingly, the other ports must cope with the unsupported instruction by at least neglecting the unsupported instruction or allocating a similar operation with respect to the unsupported instruction. Consequently, it becomes necessary to redesign and newly create the ports, which results in increased cost and development time.

On the other hand, the conventional multiprocessor system has a second problem in that the system has a low resistance and is weak with respect to an erroneous operation of the port.

For example, when writing data to an input/output circuit such as an external storage unit at the end of the bus bridge unit, the process advances to the next process without carrying out an error check when the write data is supplied to the port forming the bus bridge unit, on a precondition that the write with respect to the input/output circuit will be successful. If a write error with respect to the input/output circuit is generated or a parity error is generated on the second bus system 6, the data is not written correctly, and the bus bridge unit asynchronously notifies the generation of the error by an interrupt.

However, it is impossible to judge which access caused the error to be generated, and particularly, it is impossible to judge which write caused the error. For this reason, if the operation is continued, there is a possibility that an erroneous data will be used. Accordingly, the entire system is conventionally shut down in such a case, so as to protect the data. But this means shutting down the system every time an optional unit such as the input/output circuit fails, and the resistance of the system becomes low and the system becomes weak with respect to the erroneous operation of the port.

### DISCLOSURE OF THE INVENTION

Accordingly, it is a general object of the present invention to provide a novel and useful multiprocessor system in which the problems described above are eliminated.

Another and more specific first object of the present invention is to provide a multiprocessor system having a structure which can easily expand the scale and functions.

Still another and more specific second object of the present invention is to provide a multiprocessor system having a structure which has a high resistance and is strong with respect to an erroneous operation of a port.

A further object of the present invention is to provide a multiprocessor system provided with a plurality of ports forming processors or bus bridge units, comprising a system controller coupling said plurality of ports via address buses and control signal lines; a data bus controller coupling said plurality of ports via data buses; and a conversion unit converting at least one of commands, data and control signals at an intermediate part of a transfer path which is formed by at least one of the address buses, the data buses and the control signal lines. According to the present invention, it is possible to realize a multiprocessor system having a structure which has a high resistance and is strong with respect to an erroneous operation of a port, and the first object described above can be realized.

The conversion unit may convert a port ID for identifying each of the ports so as to expand a range of values the port ID takes.

The multiprocessor system may further comprise delay means for delaying information transferred on at least one of the address buses, the data buses and the control signal lines, so that arbitration results become at least relatively same at each of the ports and the system controller.

Another object of the present invention is to provide a multiprocessor system having the structure described above, and wherein the address buses, the data buses and the control signal lines form a first bus system, the ports forming the bus bridge units are coupled to-a second bus system which is different from the first bus system, and said conversion unit includes an error monitoring section which monitors an error notification on an error generated in the second bus system, and an off-line controller which invalidates an access related to the bus bridge units in response to the error notification. According to the present invention, it is possible to realize a multiprocessor system having a structure which has a high resistance and is strong with respect to an erroneous operation of a port, and the second object described above can be realized.

The off-line controller may invalidate a portion or all of accesses from the ports forming the bus bridge units to other ports or the system controller.

Still another object of the present invention is to provide a multiprocessor system having a plurality of ports coupled to a bus, characterized by a conversion unit converting a signal transmitted on the bus at an intermediate part of a transfer path formed by the bus. According to the present invention, it is possible to realize a multiprocessor system having a structure which has a high resistance and is strong with respect to an erroneous operation of a port, and the first object described above can be realized.

In this case, a total number of ports coupled to said bus may be larger than a total number of transfer destinations which can be represented by at least one of the plurality of ports.

Other objects and further features of the present invention will be apparent from the following detailed description when read in conjunction with the accompanying drawings.

### BRIEF DESCRIPTION OF THE DRAWING

FIG. 1 is a system block diagram showing an example of a structure of a conventional multiprocessor system;

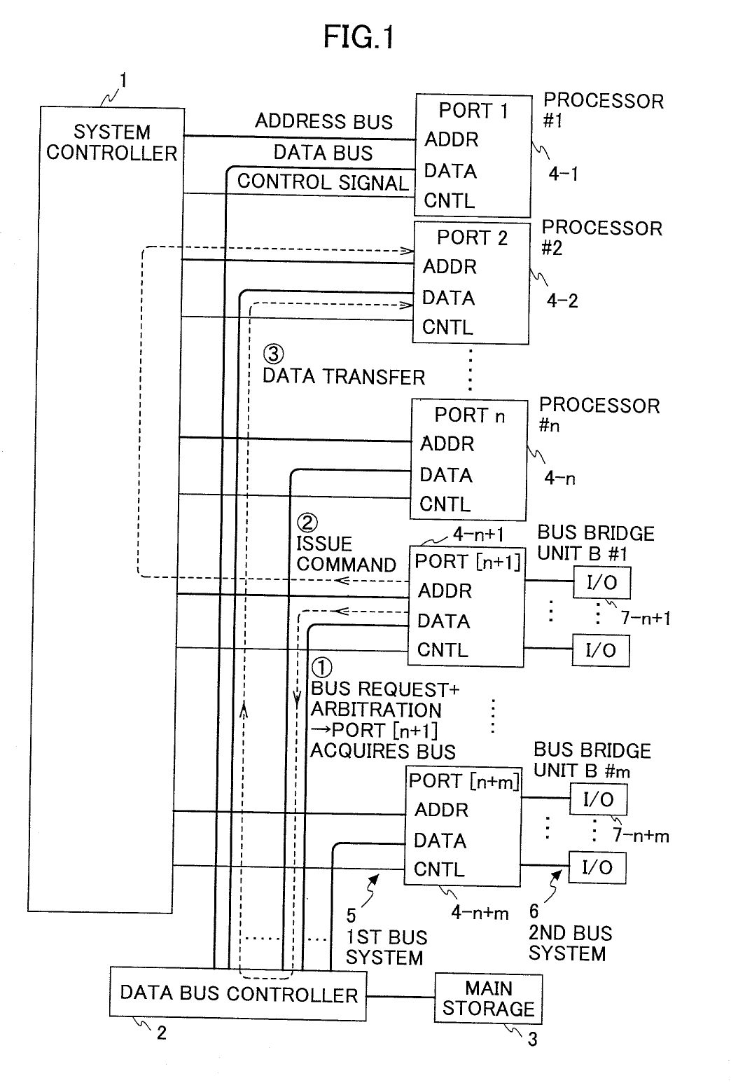

FIG. 2 is a system block diagram for explaining a distributed arbitration;

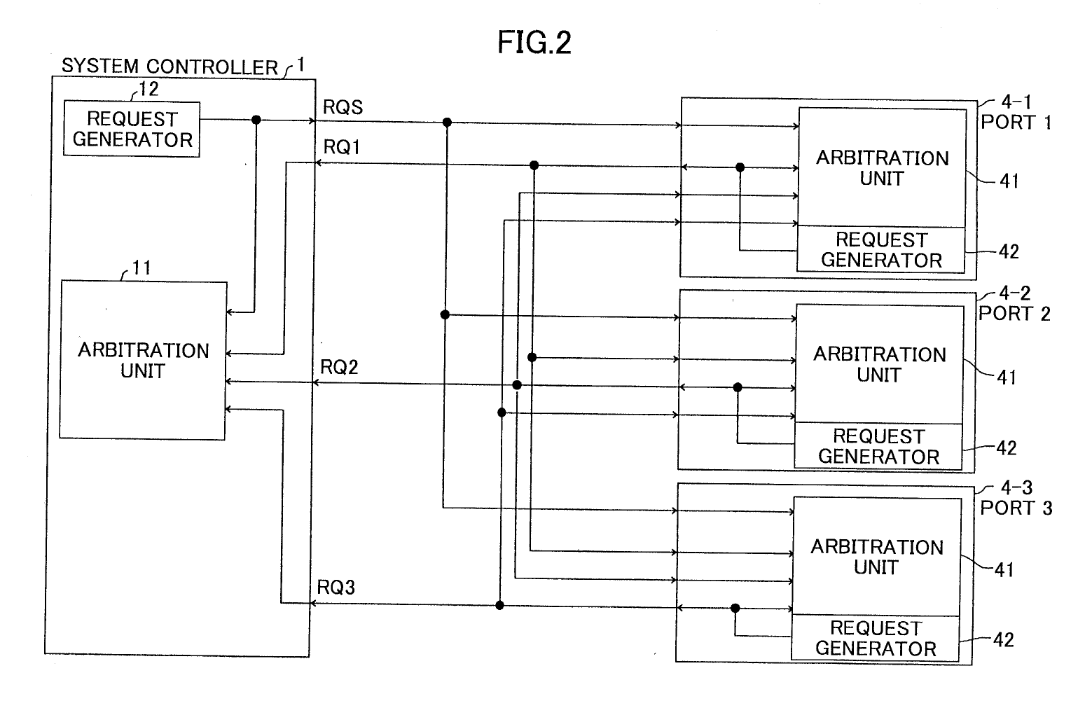

FIG. 3 is a diagram showing operation timings of a system controller for explaining the distributed arbitration;

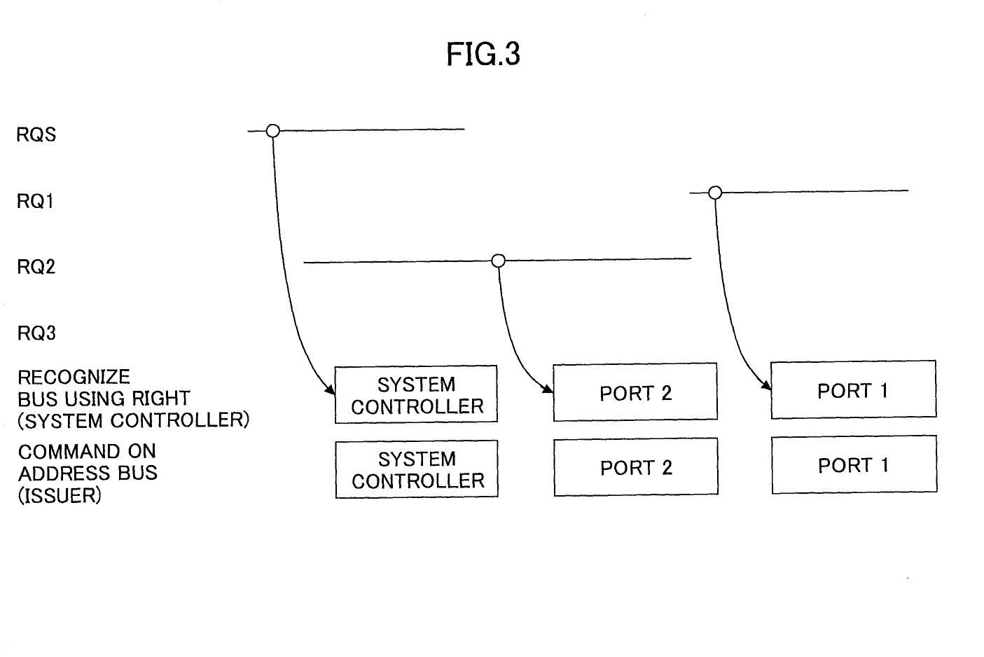

FIG. 4 is a diagram showing operation timings of a port for explaining the distributed arbitration;

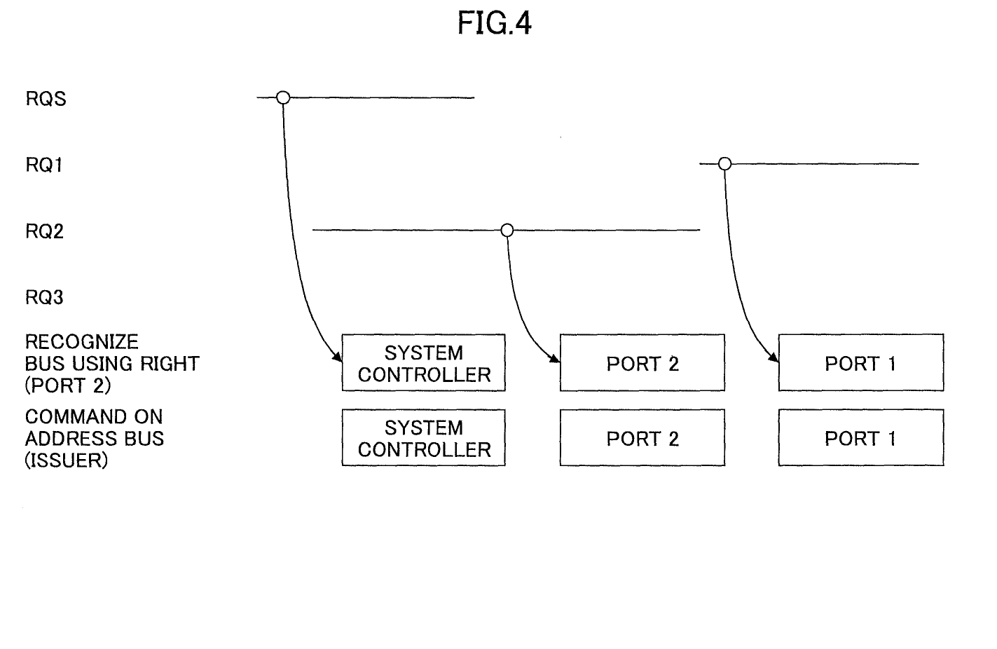

FIG. 5 is a system block diagram for explaining a concentrated arbitration;

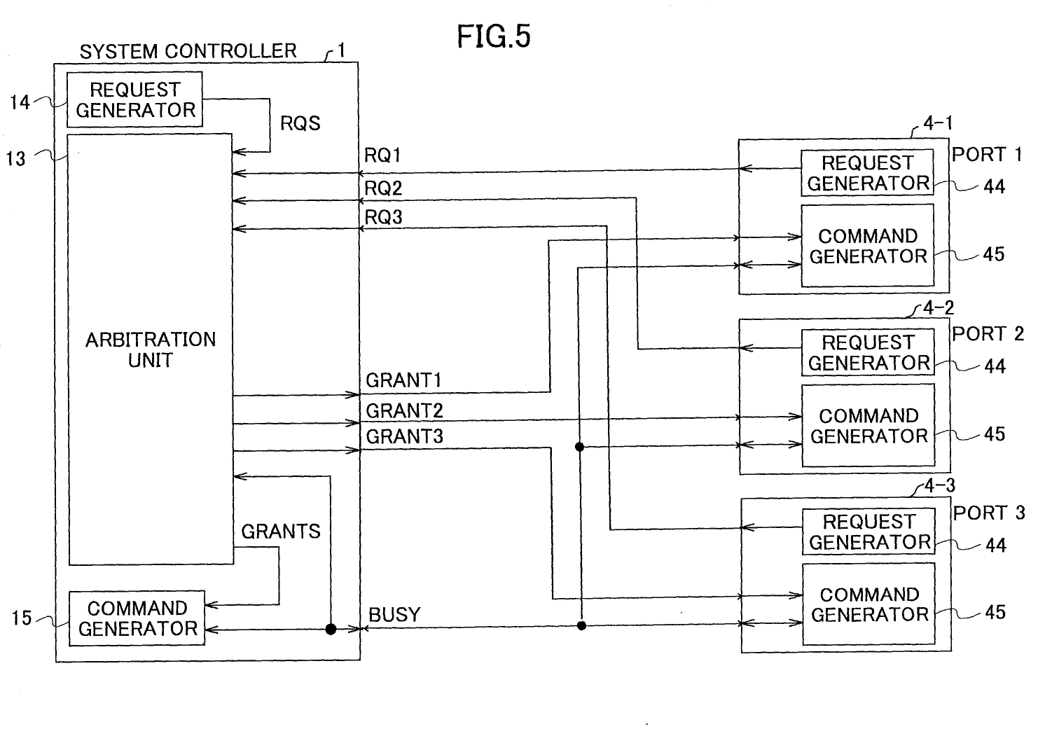

FIG. 6 is a diagram showing operation timings of the system controller for explaining the concentrated arbitration;

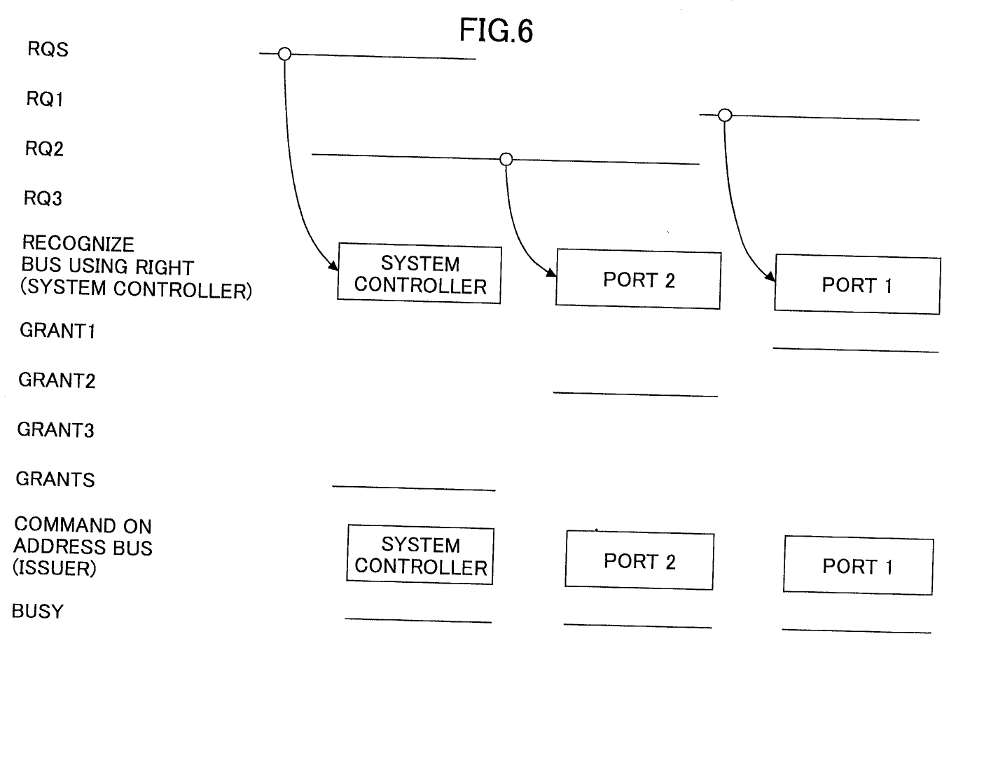

FIG. 7 is a system block diagram showing an entire structure of a multiprocessor system for explaining the operating principle of the present invention;

FIG. 8 is a system block diagram showing a structure of a conversion unit for explaining the operating principle of the present invention;

FIG. 9 is a system block diagram showing an entire structure of a first embodiment of a multiprocessor system according to the present invention;

FIG. 10 is a system block diagram showing a structure of a conversion unit of the first embodiment;

FIG. 11 is a diagram for explaining operation timings of the first embodiment;

FIG. 12 is a system block diagram showing an entire structure of a second embodiment of the multiprocessor system according to the present invention; and

FIG. 13 is a flow chart for explaining the operation of the second embodiment.

### BEST MODE OF CARRYING OUT THE INVENTION

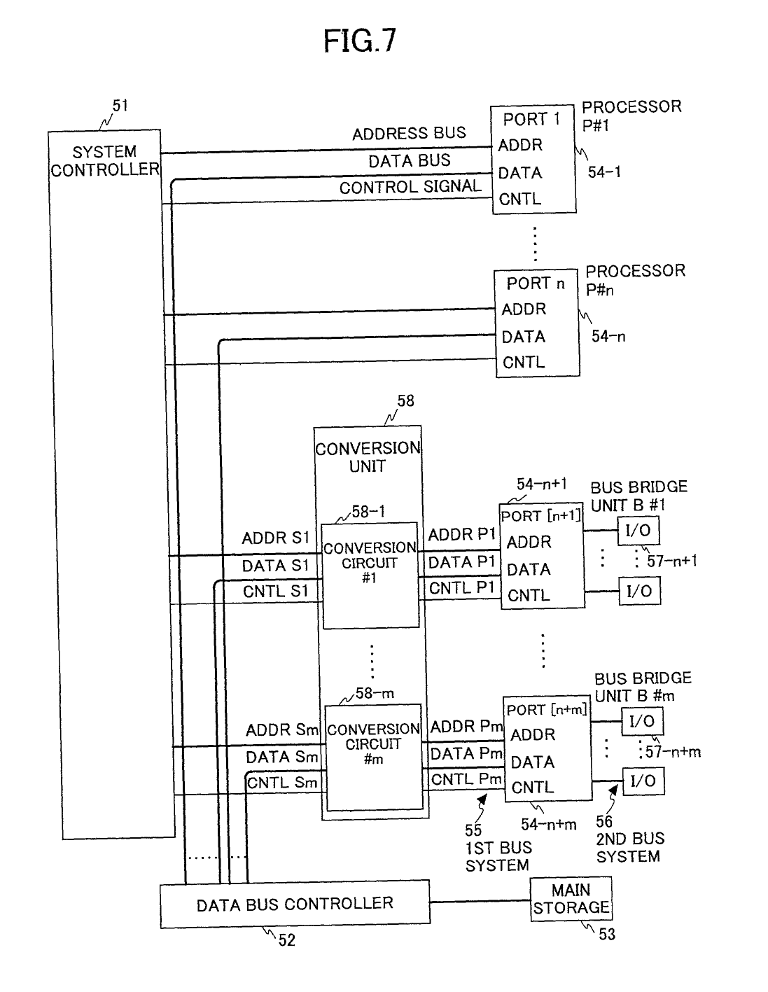

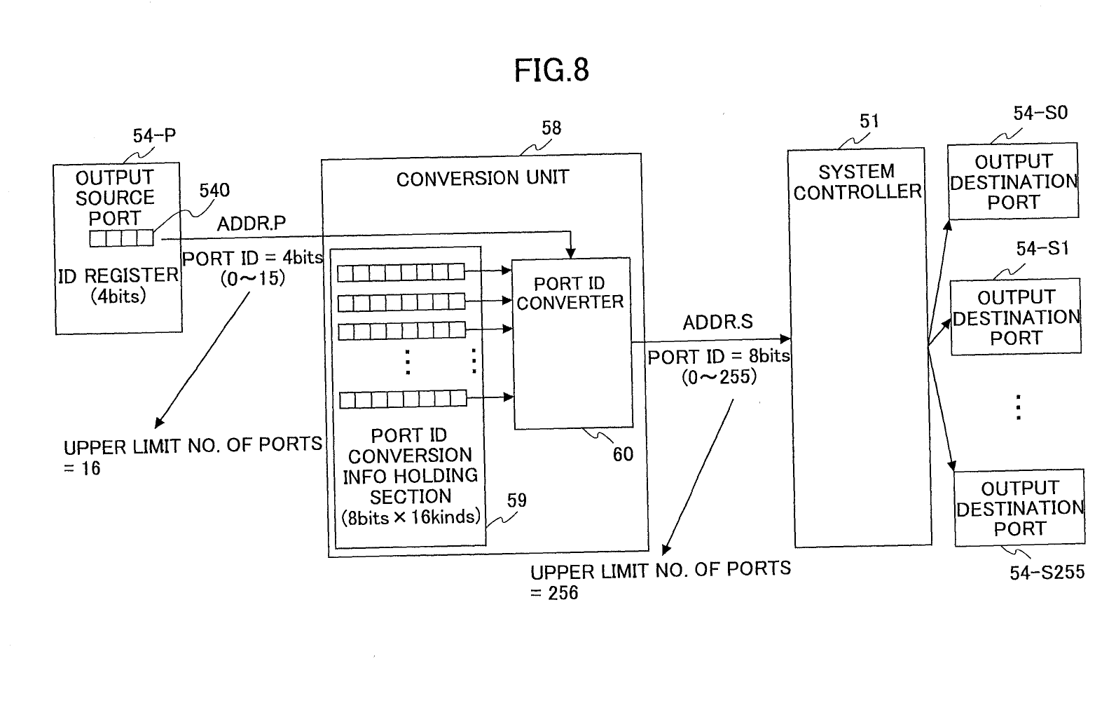

First, a description will be given of the operating principle of the present invention, by referring to FIGS. 7 and 8. FIG. 7 is a system block diagram showing an entire structure of a multiprocessor system for explaining the operating principle of the present invention. In the present invention, a conversion unit for converting at least one of a command, data and control signal is provided at an intermediate part of a transfer path which is formed by at least one of an address bus, data bus and control signal line.

As shown in FIG. 7, the multiprocessor system generally includes a system controller 51, a data bus controller 52, a main storage 53, a plurality of ports 54-1 through 54-n+m, and a conversion unit 58 which are connected as shown. The ports 54-1 through 54-n+m form processors such as CPUs, bus bridge units or the like. It is assumed for the sake of convenience that the ports 54-1 through 54-n respectively form processors P#1 through P#n, and the ports 54-n+1 through 54-n+m respectively form bus bridge units B#1 through B#m. Of course, a plurality of system controllers may be provided in place of the system controller 51.

It is also assumed for the sake of convenience that address buses, data buses and control signal lines of a first bus system 55 form a transfer path in which the conversion unit 58 is provided. More particularly, the conversion unit 58 is provided at an intermediate part of the address buses, the data buses and the control signal lines with respect to the bus bridge units B#1 through B#m which are formed by the ports 54-n+1 through 54-n+m. The conversion unit 58 includes conversion circuits 58-1 through 58-m for carrying out necessary conversions.

The ports 54-1 through 54-n+m are mutually connected via the first bus system 55. More particularly, the ports 54-1 through 54-n+m are connected via the system controller 51 and the address buses and the control signal lines of the first bus system 55, and connected via the data bus controller 52 and the data buses of the first bus system 55. In addition, the corresponding conversion circuits 58-1 through 58-m of the conversion unit 58 are provided at the intermediate part of the address buses and the control signal lines of the first bus system 55 between the system controller 51 and the ports 54-n+1 through 54-n+m. Further, the corresponding conversion circuits 58-1 through 58-m of the conversion unit 58 are provided at the intermediate part of the data buses of the first bus system 55 between the data bus controller 52 and the ports 54-n+1 through 54-n+m.

The ports 54-n+1 through 54-n+m forming the bus bridge units B#1 through B#m are connected to input/output (I/O) circuits 57-n+1 through 57-n+m via a second bus system 56 which is different from the first bus system 55. The input/output circuits 57-n+1 through 57-n+m are formed by external storage units, network apparatuses or the like. The address buses transfer commands between the ports 54-n+1 through 54-n+m and the system controller 51, and the data buses transfer data between each of the ports 54-n+1 through 54-n+m and the main storage 53 via he data bus controller 52. The control signal lines supply control signals from the system controller 51 to the ports 54-n+1 through 54-n+m, and control operations of the ports 54-n+1 through 54-n+m.

One address bus may be provided with respect to each of the ports 54-n+1 through 54-n+m as shown in FIG. 7 or, one address bus may be shared by a plurality of ports. In addition, the data bus controller 52 may have a handshake structure for directly connecting the data buses or, a structure using a crossbar switch.

In FIG. 7, ADRP1 through ADRPm denote addresses prior to the conversion, DATAP1 through DATAPm denote data prior to the conversion, and CNTLP1 through CNTLPm denote control signals prior to the conversion. Further, ADRS1 through ADRSm denote addresses after the conversion, DATAS1 through DATASm denote data after the conversion, and CNTLS1 through CNTLSm denote control signals after the conversion.

FIG. 8 is a system block diagram showing the structure of the conversion unit 58 for explaining the operating principle of the present invention. For the sake of convenience, FIG. 8 shows a case where an upper limit of a port number of a 4-bit port ID issued from an output source port 54-P is 16, and the conversion unit 58 converts the port ID into an 8-bit port ID having an upper limit port number which is 256, without changing the port structure.

The output source port 54-P includes a 4 bit ID register 540, and a 4-bit port ID from the ID register 540 is supplied to a port ID converter 60 within the conversion unit 58. The port ID converter 60 converts the 4-bit port ID into the 8 bit port ID based on port ID conversion information in the form of a table within a holding section 59 which holds 16 kinds of 8-bit port ID conversion information. The 8-bit port ID is supplied to the system controller 51, and 256 output destination ports 54-S0 through 54-S255 can be specified thereby. In other words, by expanding the port ID from 4 bits into 8 bits, it is possible in this case to specify 256 output destination ports 54-S0 through 54-S255.

When converting the port ID in the conversion unit 58, it is possible to carry out a conversion which adds predetermined bits to the port ID, such as adding upper 4 bits, for example, in place of converting all bits using the table as described above.

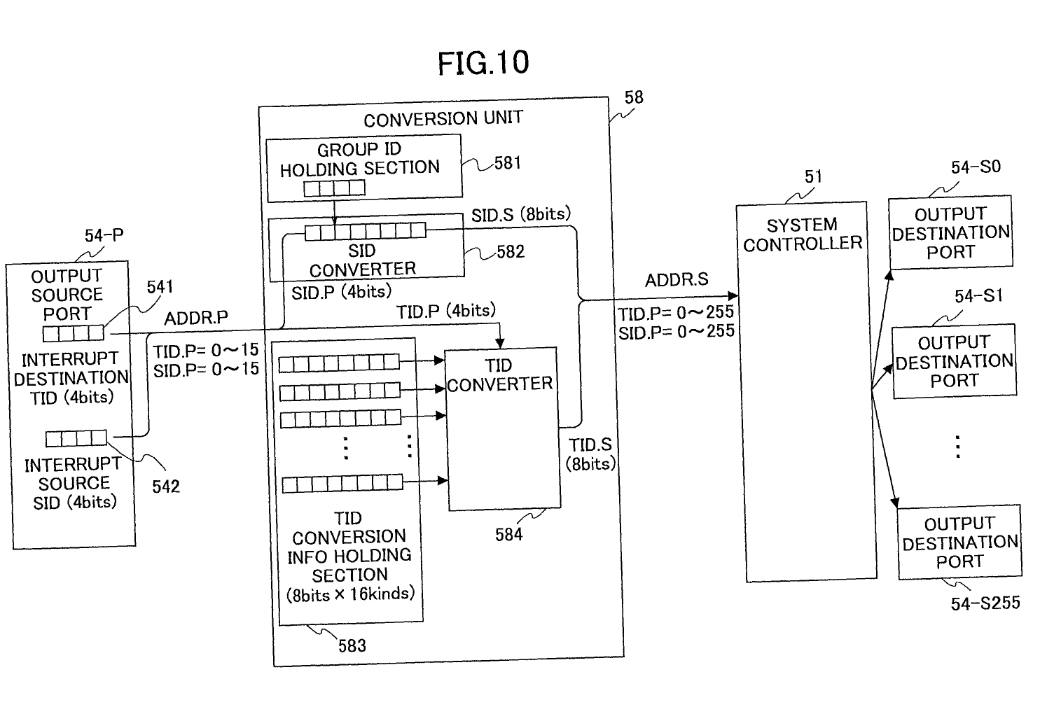

In the case shown in FIG. 10, the port ID of the output destination is expanded, but it is of course possible to expand the port ID of the output source. In other words, it is possible to increase the number of ports regardless of whether the port is the output source or the output destination. Moreover, although the port ID is expanded in this embodiment, the present invention is not limited to such expansion. For example, it is possible to convert an instruction code or convert a timing of a control signal. It is also possible to convert requests, commands, error notifications and the like issued from the port into something else or, to newly generate such requests, commands, error notifications and the like.

Therefore, the present invention converts the original functions and operations of the port by the conversion unit 58 which is functionally isolated from the port. As a result, it is possible to easily expand the scale and function of the multiprocessor system without the need to change the port structure.

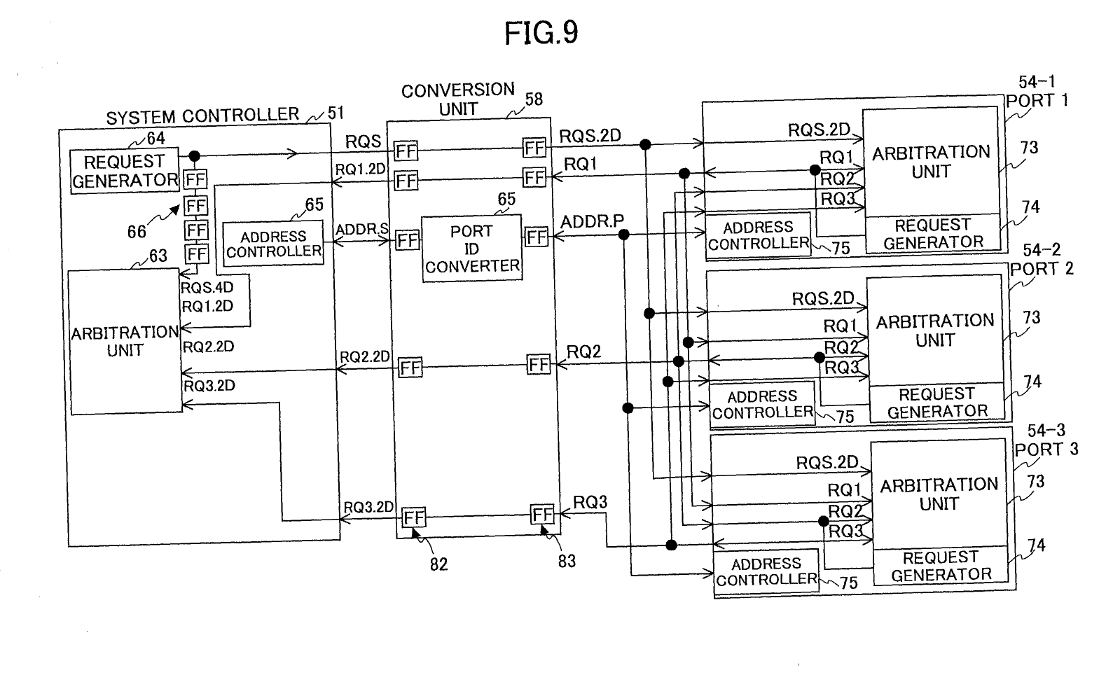

Next, a description will be given of a first embodiment of the multiprocessor system according to the present invention. FIG. 9 is a system block diagram showing the entire structure of the first embodiment of the multiprocessor system. In FIG. 9, those part which are the same as those corresponding parts in FIG. 7 are designated by the same reference numerals, and a description thereof will be omitted.

For the sake of convenience, FIG. 9 only shows one system controller 51, three ports 54-1 through 54-3, and a conversion unit 58 which connects the system controller 51 and the three ports 54-1 through 54-3. The system controller 51 includes an arbitration unit 63, a request generator 64, an address controller 65, and a plurality of flip-flops 66. In addition, each of the ports 54-1 through 54-3 includes an arbitration unit 73, a request generator 74, and an address controller 75. The conversion unit 58 includes a port ID converter 81, a plurality of flip-flops 82 connected to the system controller 51, and a plurality of flip-flops 83 connected to the ports 54-1 through 54-3.

In FIG. 9, RQS denotes a request from the request generator 64 of the system controller 51, and RQ1 through RQ3 denote requests from the request generators 74 of the ports 54-1 through 54-3. In addition, ADDR denotes the address, ADDR.P denotes the address prior to the conversion obtained from the address controller 75 prior to the conversion, and ADDR.S denotes the address after the conversion obtained from the conversion unit 58. Furthermore, the requests RQ1 through RQ3 which are respectively delayed by n within the conversion unit 58 are respectively denoted by RQ1.nD through RQ3.nD. In this embodiment, n=2. In addition, the request RQS which is delayed by 4τ in the 4 flip-flops 66 is denoted by RQS.4D.

The arbitration unit 73 of each of the ports 54-1 through 54-3 uses the requests RQ1 through RQ3. The arbitration unit 63 of the system controller 51 uses the requests RQS.4D and RQ1.2D through RQ3.2D. Moreover, the addresses ADDR.S and ADDR.P on the address buses are delayed by 2τ in the flip-flops 82 and 83 within the conversion unit 58 before being supplied to the ports 54-1 through 54-3 and the system controller 51 on opposite ends. As will be described later, the port ID converter 81 within the conversion unit 58 converts the port ID within the command.

FIG. 10 is a system block diagram showing the structure of the conversion unit 58 of the first embodiment. In FIG. 10, those parts which are the same as those corresponding parts in FIG. 8 are designated by the same reference numerals, and a description thereof will be omitted. For the sake of convenience, FIG. 10 shows the structure of the port ID converter 81 within the conversion unit 58 in particular, and shows a case where the interrupt is generated from the output source port with respect to the output destination port.

In FIG. 10, the port IDs supported by the output source port 54-P, that is, an interrupt destination ID TID.P which indicates the destination of the interrupt and an interrupt source ID SID.P, are both 4 bits and the upper limit of the number of ports is 16. Without changing the port structure, the conversion unit 58 converts the interrupt destination ID TID.P and the interrupt source ID SID.P into interrupt destination IDs TID.S and interrupt source IDs SID.S which are both 8 bits and the upper limit of the number of ports is 256. Accordingly, even though the number of output source ports and output destination ports in total can originally be only 16 in this structure, the first embodiment can increase the total number of ports to 256. For this reason, it becomes possible to easily build a large-scale multiprocessor system having a larger number of processors and input/output circuits.

The output source port 54-P includes a 4-bit interrupt destination ID register 541, and a 4-bit interrupt source ID register 542. The 4-bit ID RID from the ID register 541 is supplied to a TID converter 584 within the conversion unit 58 as the interrupt destination ID TID.P, and the 4-bit ID from the ID register 542 is supplied to a SID converter 582 within the conversion unit 58 as the interrupt source ID SID.P.

The SID converter 582 within the conversion unit 58 adds a 4-bit group ID held by a group ID holding section 581 to upper bit (significant) side of the interrupt source ID SID.P, so as to convert and expand the 4-bit interrupt source ID SID.P into an 8-bit interrupt source ID SID.S. The group ID indicates a group of the ports to which the output source port 54-P belongs. On the other hand, the TID converter 584 within the conversion unit 58 converts and expands the 4-bit interrupt destination ID TID.P into an 8-bit interrupt destination ID TID.S, based on TID conversion information in the form of a table within a holding section 583 which stores 16 kinds of 8-bit TID conversion information.

The 8-bit interrupt destination ID TID.S and the 8-bit interrupt source ID SID.S are supplied to the system controller 51, and 256 output destination ports 54-S0 through 54-S255 and 256 output source ports can be specified. In other words, by expanding the port ID from 4 bits into 8 bits, it is possible in this case to generate the interrupt from 256 output source ports and to generate the interrupt to 256 output destination ports.

When converting the interrupt destination ID TID.P in the conversion unit 58 shown in FIG. 10, it is possible to carry out a conversion which adds predetermined bits, such as adding upper 4 bits, for example, in place of converting all bits using the table as described above, similarly to the conversion of the interrupt source ID SID.P. Further, when converting the interrupt source ID SID.P, it is possible to convert all bits using the table, similarly to the conversion of the interrupt destination ID TID.P.

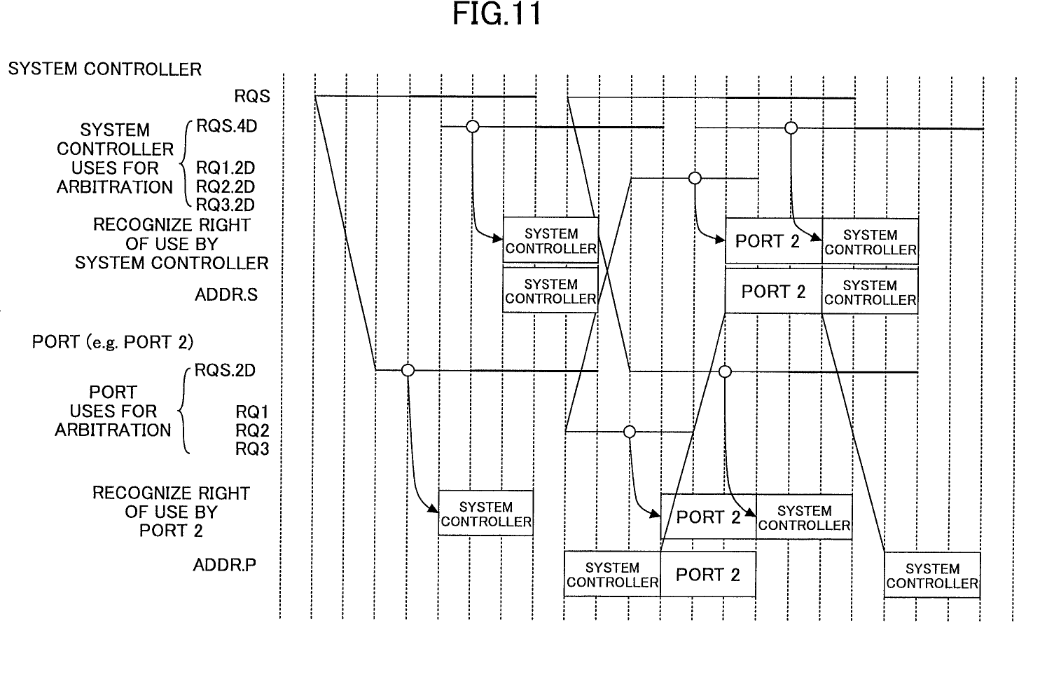

FIG. 11 is a diagram for explaining the operation timings of the first embodiment. FIG. 11 particularly shows the operation timings related to arbitration. The upper portion of FIG. 11 shows the operation timings of the system controller 51, and the lower portion of FIG. 11 shows the operation timings of the port 54-2, for example.

This embodiment employs the distributed arbitration. In this case, even if the conversion unit 58 is inserted at an intermediate part of the address buses and the control signal lines in order to delay the signals, it is essential to be aware of and appropriately control the timings of the arbitration-related signals in order to normally operate the multiprocessor system having the plurality of ports. When controlling the timings of the arbitration-related signals, it is necessary to (1) maintain consistency of the arbitration, and (2) avoid bus fight, as described hereunder.

(1) Maintaining Consistency of Arbitration:

At the port and at the system controller on opposite ends of the conversion unit 58, the arbitration result must match at least from the point of view of the phase relationship.

Accordingly, this embodiment carries out a control so that the phase relationship of each request used for the arbitration becomes the same at the port and at the system controller. More particularly, the timings of the requests RQS and RQ1 through RQ3 input to the arbitration units 63 and 73 are adjusted by the flip-flops 66, 82 and 83, so that the request RQS from the system controller 51 is delayed in this case by 2 compared to the requests RQ1 through RQ3 from the ports 54-1 through 54-3. In other words, at the system controller 51, the request RQS.4D is delayed by 2 compared to the requests RQ1.2D through RQ3.2D, and at each of the ports 54-1 through 54-3, the request RQS.2D is delayed by 2τ compared to the requests RQ1 through RQ3. Hence, the arbitration results obtained at the port and at the system controller match, with the timing difference of 2τ.

A delay circuit, such as the flip-flops, for adjusting the timings of the requests, may be provided within the system controller 51 or within the conversion unit 58, instead of being provided on both the port and the system controller as in the case of this embodiment.

(2) Avoiding Bus Fight

As a result of the arbitration, the port or the system controller recognizes the bus using right independently. However, the command which actually appears on the bus may be different from the recognition. For example, in FIG. 11, such a different recognition occurs at the port 54-2 in a case of the command from the system controller 51. Accordingly, it is necessary in such a case to avoid a bus fight in which a plurality of commands overlap on the bus.

In order to prevent the bus fight, an end of the request used for the arbitration is extended, and the issuance of a new address is suppressed at a location where the command reaches with a delay. That is, the fact that the next port cannot acquire the bus using right unless the preceding request ends, is utilized effectively.

In the case of the port 54-2 shown in FIG. 11, the port 54-2 wins the arbitration as indicated by “∘” after r from the end of the request RQS.2D, and the port 54-2 acquires the bus using right after a further 1τ and at the same time a command is issued. In order to prevent the command issued from the port 54-2 and the delayed command issued from the system controller 51 from overlapping, the ends of the request RQS.2D and the original request RQS are extended by 4τ, and output until 2τ before the end of the command issued from the system controller 51.

Therefore, it becomes possible to avoid the bus fight. In this case, the amount of extending the request may be 4τ or more, and the longer the amount of extension, the longer the intervals of the commands. In addition, the requests may be extended within the system controller 51 or outside the system controller 51.

According to this embodiment, it is possible to increase the number of ports that can be handled, without changing the port structure. In addition, by appropriately controlling the timings of the arbitration-related signals, it is possible to guarantee normal operation of the multiprocessor system even when the conversion unit 58 is inserted. Consequently, it is possible to easily build a large-scale multiprocessor system provided with a larger number of processors and input/output circuits.

Although this embodiment expands the port ID included in the command, it is also possible to convert the instruction included in the command. For example, when newly introducing a high-performance processor which can operate at a high operation speed and includes a new unsupported instruction, and improving the performance of the multiprocessor system by increasing the operation frequency, there is a possibility that an erroneous operation or fault will occur if the unsupported instruction is issued accidentally due to a programming error or the like.

Hence, in a modification of this embodiment, an unsupported instruction converter may be provided in place of the port ID converter 81 shown in FIG. 9. In this case, if a command including the unsupported instruction is issued, the unsupported instruction converter converts the unsupported instruction into an appropriate one of supported instructions. The appropriate supported instruction refers to a supported instruction which does not involve a specific operation, an instruction which carries out an operation similar to the unsupported instruction, or the like. According to this modification, it is possible to avoid an erroneous operation and fault which are generated by the accidental issuance of the unsupported instruction, without changing the port structure, and to easily expand the functions of the multiprocessor system using a high-performance processor having an unsupported instruction.

In the first embodiment described above, the multiprocessor system uses the distributed arbitration. Hence, the requests such as bus acquisition requests are mutually exchanged between the system controller and each port, and the arbitration is carried out at the system controller and each port based on the requests, to independently judge the bus using right. In addition, the function of controlling the end timings of the requests or, the function of delaying the commands and the data, is provided. Furthermore, a control is carried out so that the arbitration results at each port and the system controller become relatively the same, and a control is carried out so that the output of the conversion unit and the output of the system controller or the port will not collide on the bus.

On the other hand, the first embodiment described above is also applicable to a multiprocessor system using the concentrated arbitration. In other words, the multiprocessor system may use the concentrated arbitration, and an arbitration controller may be provided. Each port may output a request and a bus busy signal to the arbitration controller, and the arbitration controller may output a grant signal to each port, so that the arbitration controller carries out the arbitration to determine the bus using right. The function of controlling the timing of at least one of the request, the bus busy signal and the grant signal or, the function of delaying the command or the data within the conversion unit may be provided. A control may be carried out so that the output of the conversion unit and the output of the system controller or the port will not collide on the bus.

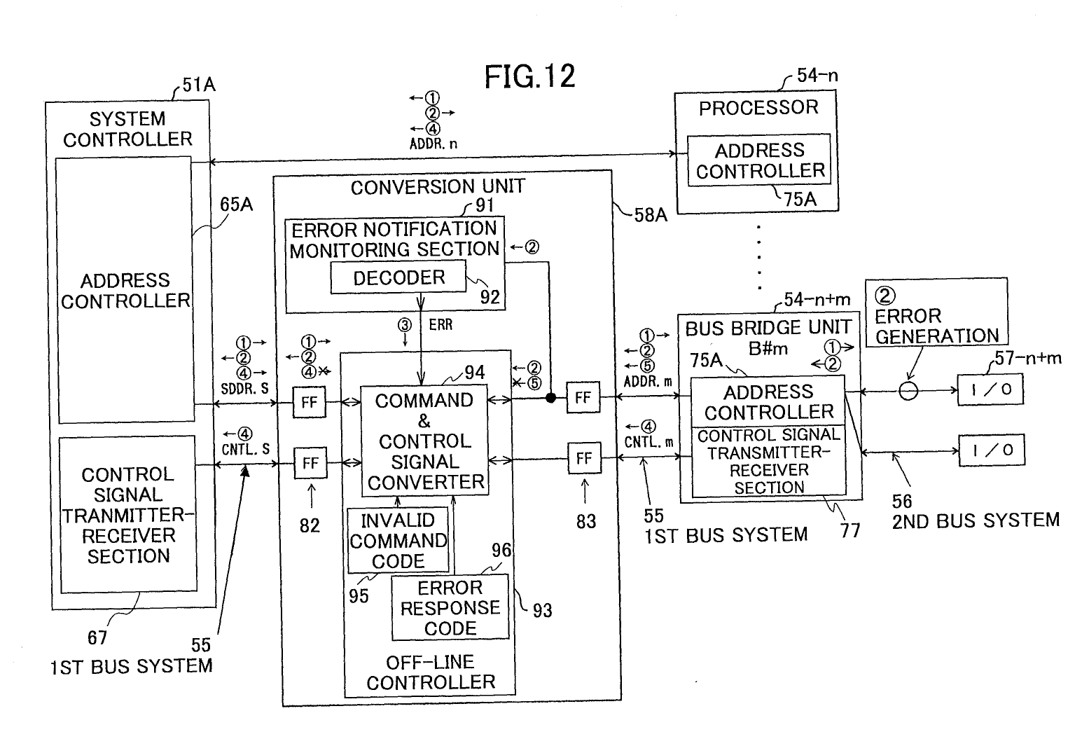

Next, a description will be given of a second embodiment of the multiprocessor system according to the present invention. FIG. 12 is a system block diagram showing the entire structure of the second embodiment of the multiprocessor system. In FIG. 12, those parts which are the same as those corresponding parts in FIGS. 7 and 9 are designated by the same reference numerals, and a description thereof will be omitted. For the sake of convenience, the illustration of the data path is omitted in FIG. 12.

In this second embodiment, an error notification monitoring section and a command and control signal converter are provided within the conversion unit. The error notification monitoring section detects an error notification interrupt issued from the bus bridge unit by decoding the command. The command and control signal converter converts the command and the command signal into an invalid command code and an error response code, respectively, based on an error signal output from the error notification monitoring section.

As shown in FIG. 12, a system controller 51A includes an address controller 65A and a control signal transmitter-receiver section 67 which transmits and receives the control signal. The port 54-n which forms the processor P#n includes an address controller 75A. The port 54-n+m which forms the bus bridge B#m includes an address controller 75A and a control signal transmitter-receiver section 77 which transmits and receives the control signal. In addition, a conversion unit 58A includes an error notification monitoring section 91, an offline controller 93, and a plurality of flip-flops 82 and 83. The error notification monitoring section 91 includes a decoder 92. On the other hand, the off-line controller 93 includes a command and control signal converter 94, an invalid command code register 95 which holds an invalid command code, and an error response code register 96 which holds an error response code.

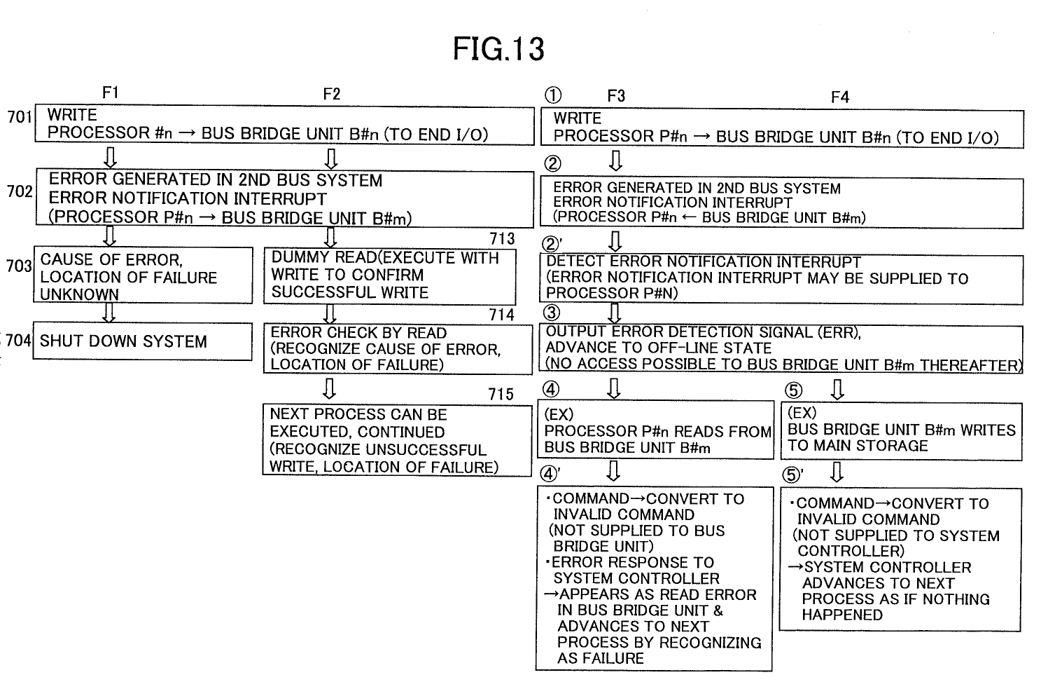

FIG. 13 is a flow chart for explaining the operation of the second embodiment. In FIG. 13, steps shown under F1 and F2 indicate processes which are carried out in a case where the conversion unit 58A of this embodiment is not provided, and steps shown under F3 and F4 indicate the processes which are carried out in a case where the conversion unit 58A of this embodiment is provided. Steps \mathring{1} through \mathring{5} shown in FIG. 13 are also shown at corresponding locations in FIG. 12 with arrows.

In FIG. 13, F1 shows the processes for a case where no access check is made by placing importance on the operation performance. In this case, when carrying out a data write from the port 54-n which forms the processor P#n to the input/output circuit 57-n+m at the end of the port 54-n+m which forms the bus bridge unit B#m as indicated by a step 701, an error notification interrupt is generated from the bus bridge unit B#m to the processor P#n when an error such as a parity error is generated in the second bus system 56 as indicated by a step 702. However, from this error notification interrupt, it is difficult to specify the cause of error and the location of failure in a step 703. Hence, it is necessary in a step 704 to shut down the system in order to protect the data.

In FIG. 13, F2 shows the processes for a case where the system is not shut down. In this case, when carrying out a read,-a dummy read is always carried out as indicated by a step 713. In the case of the read operation, an error check can be made. Hence, a step 714 carries out an error check by the read, and specifies the cause of error or the location of failure. A step 715 can execute and continue the next process after knowing the cause of error and the location of failure. Accordingly, it is unnecessary to shut down the system in this case. However, if a write access check is carried out in this manner in synchronism, the processing speed of the system deteriorates and becomes unsuited for practical use.

Hence, this second embodiment carried out the processes of F3 or F4 shown in FIG. 13, so as to eliminate the inconveniences of the processes of F1 or F2.

In the processes of F1, in the case of a data write from the port 54-n which forms the processor P#n to the input/output circuit 57-n+m at the end of the port 54-n+m which forms the bus bridge unit B#m as shown in a step \mathring{1}, an error notification interrupt is generated from the bus bridge unit B#m to the processor P#n when an error such as a parity error is generated at the second bus system 56 as shown in a step \mathring{2}. A decoder 92 within the error notification monitoring section 91 of the conversion unit 58A monitors the error notification interrupt, and the error notification interrupt is detected in a step \mathring{2}′. The detected error notification interrupt may be supplied to the processor P#n. The decoder 92 outputs an error detection signal ERR to the command and control signal converter 94 within the off-line controller 93 to put the system into an on-line state in a step \mathring{3}. Accordingly, no access is thereafter possible with respect to the bus bridge unit B#m.

For example, when the processor P#n attempts to read from the bus bridge unit B#m in a step \mathring{4}, the command and control signal converter 94 converts the command into an invalid command code within the invalid command code register 95 in a step \mathring{4}′. In this case, it is possible to take measures so that the invalid command code is not supplied to the bus bridge unit B#m. In addition, in the step \mathring{4}′, the command and control signal converter 94 makes an error response by outputting an error response code CNTL.S within the error response code register 96 with respect to the system controller 51A. In this embodiment, the codes within the registers 95 and 96 are output from the command and control signal converter 94 when the error detection signal ERR is ERR=1. Hence, at the processor P#n and the system controller 51A, it is seen as if a read error is generated as a result of making an access with respect to the bus bridge unit B#m, and for this reason, the process advances to the next process by recognizing a generation of a failure.

In the processes of F4, the processes are the same as the processes of F3 from step \mathring{1} to the step \mathring{3}. But after the step \mathring{3}, when an attempt is made to write from the bus bridge unit B#m to the main storage 53 in a step \mathring{5}, the command and control signal converter 94 converts the command into the invalid command code within the invalid command code register 95 in a step \mathring{5}′. In this case, it is possible to take measures so that the invalid command code is not supplied to the system controller 51A. Hence, the system controller 51A advances to the next process as if nothing happened. Since the bus bridge unit B#m has the above described problem in this particular case, no problem will occur even if the bus bridge unit B#m is isolated from the system.

Therefore, according to this second embodiment, the multiprocessor system includes the first bus system connected to the system controller and the ports, the second bus system different from the first bus system, the bus bridge units having the function of connecting to the first bus system and the function of connecting to the second bus system, and the conversion unit. The conversion unit includes the error notification monitoring section which monitors the error notification generated in-the second bus system, and the off-line controller which invalidates a portion or all of the accesses from the bus bridge unit to the other ports and the system controller or, the accesses from the other ports or the system controller to the bus bridge unit, so that the access related to the bus bridge unit is invalidated in correspondence with the error notification generated in the second bus system. Moreover, the off-line controller may operate so as to convert the contents of a portion or all of the commands and the data-control signals or, to return a response such as an error response or an invalid response with respect to the access.

According to this second embodiment, it is possible to avoid the system from being shut down due to an erroneous operation carried out under the bus bridge unit. In addition, since the processing speed will not deteriorate as in the case of the processes of F2, it is possible to build a multiprocessor system having a high resistance with respect to the erroneous operation of the port.

The error notification interrupt which triggers the off-line may be supplied as it is to the processor P#n, so that the software may use this interrupt as an off-line start notification.

Further, the present invention is not limited to these embodiments, but various variations and modifications may be made without departing from the scope of the present invention.

1. A multiprocessor system provided with a plurality of ports forming processors or bus bridge units, comprising:
a system controller coupling said plurality of ports via address buses and control signal lines;
a data bus controller coupling said plurality of ports via data buses; and
a conversion unit converting at least one of commands, data and control signals at an intermediate part of a transfer path which is formed by at least one of the address buses, the data buses and the control signal lines.

2. The multiprocessor system as claimed in claim 1, wherein said conversion unit converts a port ID for identifying each of the ports so as to expand a range of values the port ID takes.

3. The multiprocessor system as claimed in claim 2, wherein said conversion unit converts an interrupt destination port ID indicating an interrupt destination or an interrupt source port number indicating an interrupt destination, included in an interrupt command.

4. The multiprocessor system as claimed in any of claims 1 to 3, further comprising:
delay means for delaying information transferred on at least one of the address buses, the data buses and the control signal lines, so that arbitration results become at least relatively same at each of the ports and the system controller.

5. The multiprocessor system as claimed in claim 1, wherein:
the address buses, the data buses and the control signal lines form a first bus system,
the ports forming the bus bridge units are coupled to a second bus system which is different from the first bus system, and
said conversion unit includes an error monitoring section which monitors an error notification on an error generated in the second bus system, and an off-line controller which invalidates an access related to the bus bridge units in response to the error notification.

6. The multiprocessor system as claimed in claim 5, wherein said off-line controller invalidates a portion or all of accesses from the ports forming the bus bridge units to other ports or the system controller.

7. The multiprocessor system as claimed in claim 5, wherein said off-line controller carries out at least one of a process which converts a portion or all of the commands, data and control signals and a process of returning a response with respect to an access.

8. A multiprocessor system having a plurality of ports coupled to a bus, characterized by:
a conversion unit converting a signal transmitted on the bus at an intermediate part of a transfer path formed by the bus.

9. The multiprocessor system as claimed in claim 8, characterized in that said bus comprises:
address buses transmitting address signals;
control signal lines transmitting control signals;
data buses transmitting data;
a system controller coupling the plurality of ports via the address buses and the control signal lines; and
a data bus controller coupling the plurality of ports via the data buses.

10. The multiprocessor system as claimed in claim 8, characterized in that a total number of ports coupled to said bus is larger than a total number of transfer destinations which can be represented by at least one of the plurality of ports.

11. The multiprocessor system as claimed in claim 8, characterized in that:
said conversion unit includes address conversion information,
said address conversion information includes information indicating correspondence of addresses of the ports coupled to the bus and numbers corresponding to said addresses, and
said ports specify transfer destination addresses by specifying said numbers.

12. The multiprocessor system as claimed in claim 11, characterized in that said numbers are within a range which can represent the ports coupled to said conversion unit as transfer destinations.
